(19) United States
(12) Patent Application Publication
(10) Pub. No.: US 2026/0145517 A1
(43) Pub. Date: May 28, 2026

(54) METHOD OF DETERMINING BLIND SPOT OF DISPLAY MODULE CAUSED BY STEERING WHEEL AND METHOD OF PROVIDING VIRTUAL EFFECT OF VEHICLE USING THE SAME

(71) Applicants: HYUNDAI MOTOR COMPANY, SEOUL (KR); KIA CORPORATION, SEOUL (KR)

(72) Inventor: Sang-Jun Park, Hwaseong-si (KR)

(73) Assignees: HYUNDAI MOTOR COMPANY, SEOUL (KR); KIA CORPORATION, SEOUL (KR)

(21) Appl. No.: 19/225,917

(22) Filed: Jun. 2, 2025

(30) Foreign Application Priority Data
Nov. 22, 2024 (KR) 10-2024-0168356

(51) Int. Cl. B60K 35/22; B60K 35/10; B60K 35/28

(52) U.S. Cl. CPC B60K 35/22; B60K 35/10; B60K 35/28; B60K 2360/149; B60K 2360/166; B60K 2360/177

(57) ABSTRACT

A method is provided of determining a blind spot of a display module caused by a steering wheel. The method includes a synchronization operation of allowing, by a control unit, one or more cameras installed on a display module to identify a driver’s eyes, a blind spot determining operation of driving, by the control unit, cameras among the one or more cameras, of which views are blocked by the steering wheel and which cannot identify the driver’s eyes and identifying the driver’s eyes, and a blind spot calculating operation of reflecting the shape of the steering wheel, which is pre-stored in the control unit, in the display module, and calculating an area of the display module, which is covered by the steering wheel and cannot be identified by the driver, by the control unit.

### CROSS REFERENCE TO RELATED APPLICATIONS

This application claims priority to Korean Patent Application No. 10-2024-0168356, filed on November 22, 2024, which is incorporated herein by reference in its entirety.

### BACKGROUND

### FIELD

The present disclosure relates to a method of determining a blind spot of a display module caused by a steering wheel, which determines an area of an interior display module of a vehicle, which cannot be identified by a driver due to the steering wheel, and generates a virtual external effect according to a traveling environment of the vehicle, and a method of providing the virtual effect of the vehicle using the same.

### DESCRIPTION OF RELATED ART

Recently, a cluster and an audio, video, navigation, telecommunication (AVNT) of a vehicle are integrated to form a single interior display module.

A part of the interior display module is used as the cluster, and another part thereof is used as the AVNT. In some vehicles, a central screen between the cluster and the AVNT is used as an area in which additional information is displayed. For example, the central screen can be used as a panel for manipulating interior air conditioning, an album for displaying images set by a user, or the like.

Meanwhile, since a steering wheel for steering the vehicle is positioned between the driver’s eyes and the interior display module, a blind spot in which a part of the display module is not visible by the steering wheel occurs.

Since the cluster and the AVNT display information necessary for driving, the cluster and the AVNT are, for the most part, not covered by the steering wheel and can be identified by the driver through the arrangement of the steering wheel and the interior display module and the position adjustment of the contents displayed on the cluster and the AVNT.

However, when the driver looks at the central screen, the contents displayed on the central screen are not visible by the steering wheel because the central screen is covered by the steering wheel.

An image similar to an image of the vehicle captured from the outside is virtually generated by combining shapes near the vehicle using a camera mounted at an outer side of the vehicle and provided through the interior display module.

However, the image is always provided as the same image regardless of a driving state of the vehicle, thereby lowering the driver’s enjoyment.

### SUMMARY

The present disclosure has been invented to solve the above problems and is directed to providing a method of determining a blind spot of a display module caused by a steering wheel, which determines an area of an interior display module of a vehicle, which cannot be identified by a driver due to the steering wheel, and a method of providing the virtual effect of the vehicle using the same.

The present disclosure is also directed to providing a method of determining a blind spot of a display module caused by a steering wheel, which enables a driver to enjoy driving by providing a virtual external image suitable for a traveling environment of the vehicle, and a method of providing the virtual effect of the vehicle using the same.

To achieve the above objects, according to the present disclosure, there is provided a method of determining a blind spot of a display module caused by a steering wheel, which includes a synchronization operation of allowing, by a control unit, one or more cameras installed on a display module to identify a driver’s eyes, a blind spot determining operation of driving, by the control unit, a camera among the one or more cameras, of which a view is blocked by a steering wheel and which is unable to identify the driver’s eyes, and identifying the driver’s eyes, and a blind spot calculating operation of reflecting, by the control unit, a shape of the steering wheel, which is pre-stored in the control unit, in the display module and calculating an area of the display module, which is covered by the steering wheel and is unable to be identified by the driver.

The synchronization operation includes a synchronization start operation in which the one or more cameras each start to identify the driver’s eyes, and a covered camera determining operation of determining whether a covered camera among the one or more cameras, which is covered by the steering wheel and is unable to identify the driver’s eyes, is present.

The method further includes a synchronization completion determining operation of determining whether the one or more cameras have started to identify the driver’s eyes between the synchronization start operation and the covered camera determining operation.

The blind spot determining operation includes a first position determining operation of determining whether a covered camera which is covered by the steering wheel and is unable to be identified by the driver is positioned at an apex of a central screen of the display module, a second position determining operation of determining whether the covered camera is positioned at a horizontal or vertical side of the central screen, a camera driving operation of driving the covered camera and identifying the driver’s eyes, and an information storing operation of storing, by the control unit, distance information between each camera and the driver’s eyes.

In the first position determining operation, when the covered camera is positioned at the apex of the central screen, the control unit vertically moves or vertically tilts the covered camera so that the covered camera identifies the driver’s eyes and collects the distance information, and the control unit moves or tilts the covered camera in a left-right direction so that the covered camera identifies the driver’s eyes and collects the distance information.

In the second position determining operation, when the covered camera is positioned at a vertical side of the central screen, the control unit moves or tilts the covered camera upward so that the covered camera identifies the driver’s eyes and collects the distance information, and the control unit moves or tilts the covered camera downward so that the covered camera identifies the driver’s eyes and collects the distance information.

In the second position determining operation, when the covered camera is positioned at a horizontal side of the central screen, the control unit moves or tilts the covered camera to a left so that the covered camera identifies the driver’s eyes and collects the distance information, and the control unit moves or tilts the covered camera to a right so that the covered camera identifies the driver’s eyes and collects the distance information.

The camera is a depth camera configured to recognize an object in a three-dimensional space.

Meanwhile, a method of providing a virtual effect of a vehicle, which includes a terrain mode entering operation of inputting the fact that the vehicle has entered a terrain mode to a control unit, a screen activation determining operation of determining, by the control unit, whether a content is displayed through a central screen of a display module, an effective area determining operation of determining an effective area of the central screen, which is able to be identified by a driver, and an effect exhibiting operation of exhibiting an effect according to the terrain mode of the vehicle in the effective area according to a manipulation direction of a steering wheel.

The method further includes, between the effective area identifying operation and the effect exhibiting operation, an effect area setting operation of setting an effect exhibiting area in which the effect is exhibited to a predetermined width from a blind spot of the central screen, which is covered by the steering wheel, and a steering direction determining operation of determining the manipulation direction of the steering wheel, wherein an effect exhibiting start area is determined in the effect exhibiting operation according to the manipulation direction of the steering wheel.

When the steering wheel is manipulated to turn left, the effect exhibiting operation includes exhibiting the effect from an effect area at a right of the blind spot, and when the steering wheel is manipulated to turn right, the effect exhibiting operation includes exhibiting the effect from an effect area at a left of the blind spot.

The method further includes an effect intensity calculating operation of calculating an intensity of the effect between the effective area setting operation and the steering direction determining operation.

In the effect intensity calculating operation, the control unit calculates the intensity of the effect in proportion to at least one of a speed of the vehicle and a steering angle of the steering wheel.

The method further includes, between the terrain mode entering operation and the screen activation determining operation, a specific mode determining operation of causing the driver to select a specific mode of the terrain mode, an automatic mode determining operation of determining whether an automatic mode among the specific modes of the terrain mode has been selected, and a specific mode storing operation of storing the specific mode as one of a sand mode, a mud mode, and a snow mode in the control unit.

In the automatic mode determining mode, when it is determined that the driver selects the automatic mode among the specific modes of the terrain mode, a mode identifying operation of identifying, by the control unit, whether to perform the terrain mode using one of the sand mode, the mud mode, and the snow mode is performed.

According to the method of determining a blind spot of a display module caused by a steering wheel of the present disclosure having the above configuration and the method of providing a virtual effect of a vehicle using the same, it is possible to determine the area of the interior display module of the vehicle, which is covered by the steering wheel and cannot be identified by the driver.

Accordingly, since the contents can be prevented from being displayed in the area which cannot be identified by the driver, the information necessary for the driver to drive or control the vehicle can be provided without omission.

In addition, by determining the area of the interior display module, which is covered by the steering wheel, it is possible to provide the visual effect related to the traveling environment of the vehicle to the periphery of the steering wheel.

Accordingly, since the driver can feel the fun of driving, it is possible to improve the marketability of the vehicle.

### BRIEF DESCRIPTION OF THE FIGURES

FIG. 1 is a schematic view illustrating a state in which an interior display module is covered by a steering wheel.

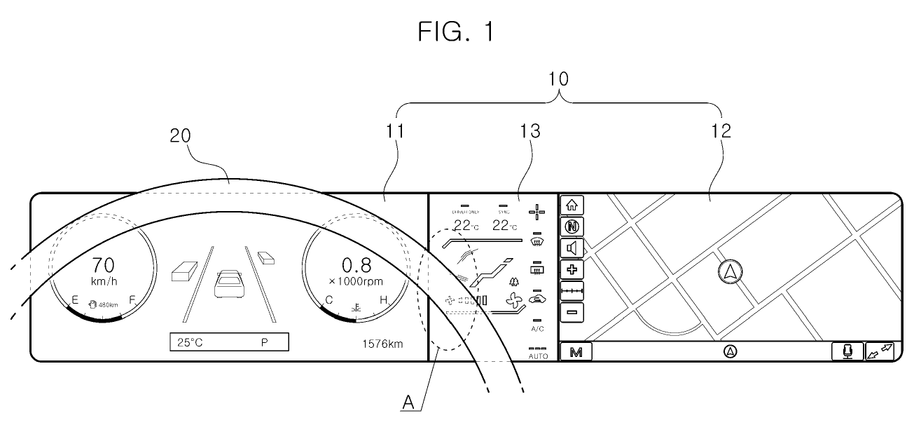

FIG. 2A is a flowchart illustrating a method of determining a blind spot of a display module caused by a steering wheel according to the present disclosure.

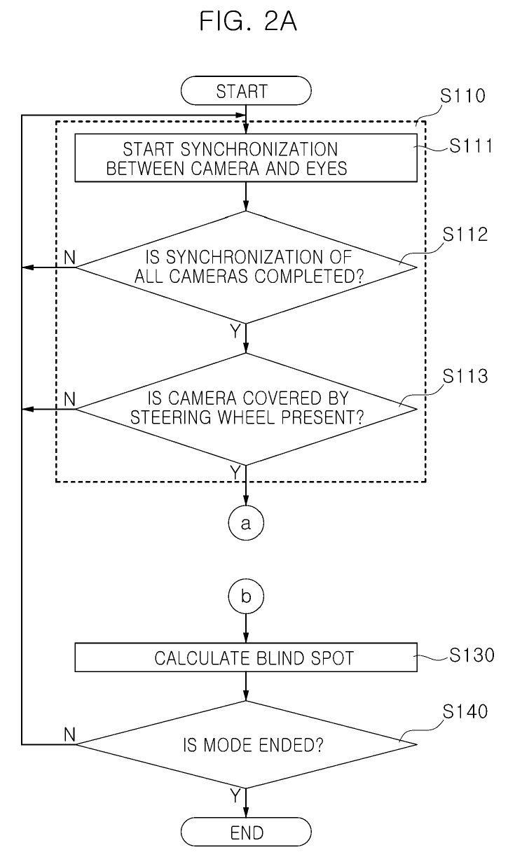

FIG. 2B is a flowchart illustrating a method of determining a blind spot of a display module caused by a steering wheel according to the present disclosure.

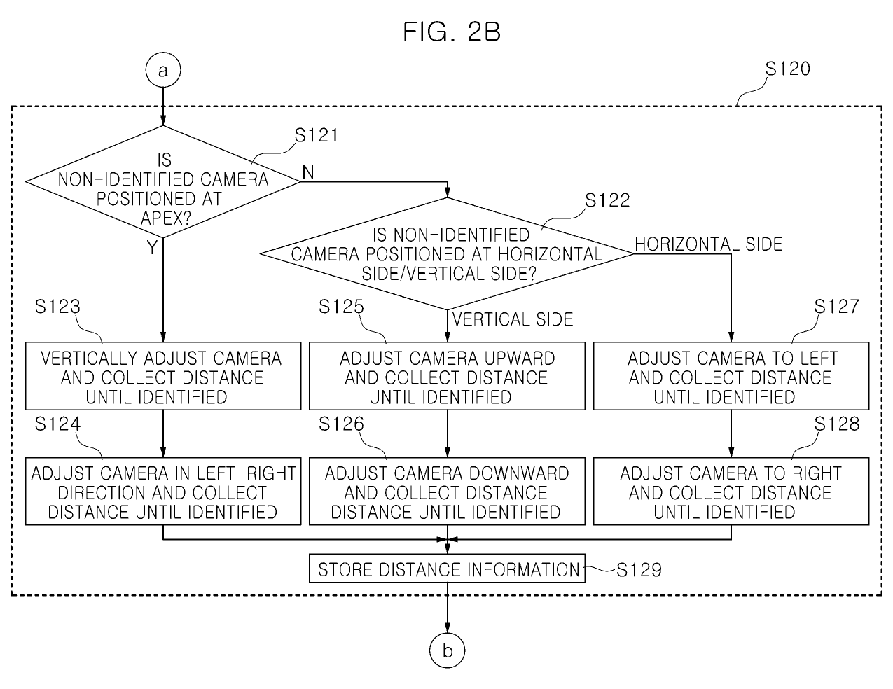

FIG. 3 is a schematic view in the method of determining a blind spot of a display module caused by a steering wheel according to the present disclosure in which a camera is installed on the central screen.

FIG. 4A is a flowchart illustrating a method of providing a virtual effect of a vehicle according to the present disclosure.

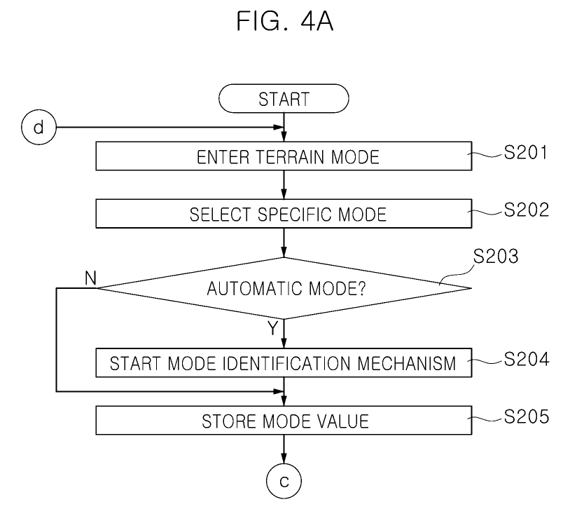

FIG. 4B is a flowchart illustrating a method of providing a virtual effect of a vehicle according to the present disclosure.

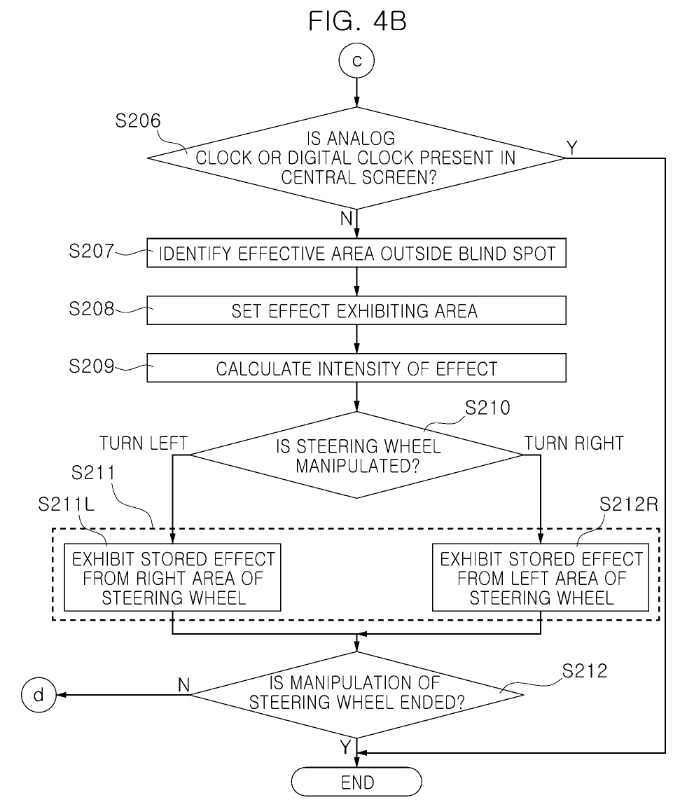

FIG. 5 is a schematic view illustrating a process for selecting an area of the interior display module, which displays an external effect around an area covered by the steering wheel.

FIG. 6 is a schematic view illustrating an example in which an image in which an external effect is applied to an audio, video, navigation, telecommunication (AVNT) is provided when a vehicle is traveling at a low speed on a sandy road according to the method of providing a virtual effect of a vehicle according to the present disclosure.

FIG. 7 is a schematic view illustrating an example in which an image in which the external effect is applied to the AVNT is provided when a vehicle is traveling at a high speed on a sandy road according to the method of providing a virtual effect of a vehicle according to the present disclosure.

### DETAILED DESCRIPTION

Hereinafter, a method of determining a blind spot of a display module caused by a steering wheel and a method of providing a virtual effect of a vehicle using the same according to the present disclosure will be described in detail with reference to the accompanying drawings.

The method of determining a blind spot of a display module caused by a steering wheel according to the present disclosure includes a synchronization operation S110 of allowing, by a control unit, one or more cameras 14a to 14h installed on a display module 10 to identify a driver’s eyes, a blind spot determining operation S120 of driving, by the control unit, cameras 14d and 14g among the one or more cameras 14a to 14h, of which views are blocked by a steering wheel 20 and which cannot identify the driver’s eyes and identifying the driver’s eyes, and a blind spot calculating operation S130 of reflecting the shape of the steering wheel 20, which is pre-stored in the control unit, in the display module 10, and calculating an area of the display module 10, which is covered by the steering wheel 20 and cannot be identified by the driver, by the control unit.

The method of determining a blind spot of a display module caused by a steering wheel according to the present disclosure is performed by the control unit because its logic is stored in the control unit.

The synchronization operation S110 includes allowing, by the control unit, the one or more cameras 14a to 14h installed on the display module 10 to identify the driver’s eyes.

The synchronization operation S110 includes a synchronization start operation S111 in which the one or more cameras 14a to 14h start to identify the driver’s eyes, a synchronization completion determining operation S112 in which the one or more cameras 14a to 14h all have started to identify the driver’s eyes, and a covered camera determining operation S113 of determining whether the cameras 14d and 14g among the one or more cameras 14a to 14h, which are covered by the steering wheel 20 and cannot identify the driver’s eyes, are present.

The one or more cameras 14a to 14h are installed at one side of the display module 10, preferably, a central screen 13 of the display module 10, which is positioned between the cluster 11 and the AVNT 12.

Since the cluster 11 and the AVNT 12 display essential information for traveling, they are disposed not to be covered by the steering wheel 20 as much as possible, but since the central screen 13 on which additional information is displayed is covered by the steering wheel 20, the one or more cameras 14a to 14h are preferably installed on the central screen 13 to determine a blind spot covered by the steering wheel 20.

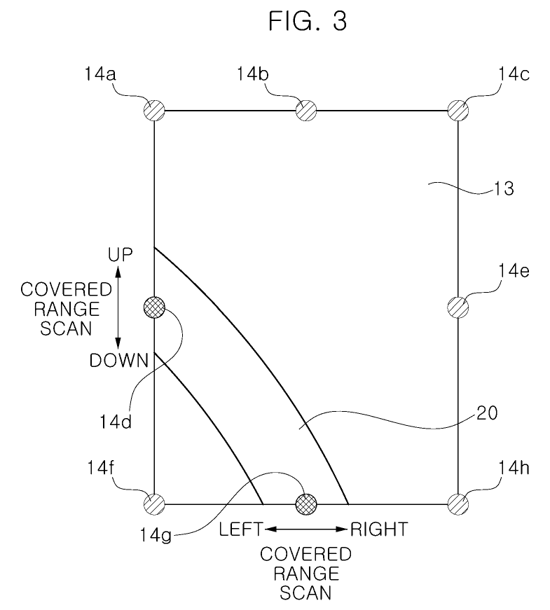

FIG. 3 illustrates an example in which the eight cameras 14a to 14h are installed from an upper left to a lower right of the central screen 13.

In addition, the cameras 14a to 14h are preferably depth cameras for recognizing objects in a three-dimensional space. Using the depth camera, a distance, direction, and the like from the depth camera to the driver’s eyes are recognized.

In the synchronization start operation S111, the one or more cameras 14a to 14h each start to identify the driver’s eyes. The one or more cameras 14a to 14h start to be operated by the control unit to identify the driver’s eyes.

The synchronization completion determining operation S112 includes determining whether the cameras 14a to 14h all have identified the driver’s eyes. By identifying the driver’s eyes from each of the cameras 14a to 14h and determining whether information such as a distance, a direction, and the like has been input by the control unit, it is possible to determine whether synchronization completion has been completed. When the cameras 14a to 14h all have identified the driver’s eyes, it means that the central screen 13 has no area covered by the steering wheel 20, and thus the process returns to the synchronization start operation S111 and the logic restarts.

The covered camera determining operation S113 includes determining whether the cameras 14g and 14h among the one or more cameras 14a to 14h, which have not detected the driver’s eyes, are present. When the cameras 14g and 14h have not identified the driver’s eyes, it means that the driver has not identified the cameras 14g and 14h due to the steering wheel 20. In addition, it means that the cameras 14g and 14h are positioned in the area covered by the steering wheel 20.

The blind spot determining operation S120 includes driving, by the control unit, the cameras 14g and 14h among the one or more cameras 14a to 14h, of which views are blocked by the steering wheel 20 and which cannot identify the driver’s eyes, to identify the driver’s eyes.

The blind spot determining operation S120 includes a first position determining operation S121 of determining whether the covered cameras 14d and 14g which are covered by the steering wheel 20 and cannot be identified by the driver are positioned at an apex of the central screen 13 of the display module 10, a second position determining operation S122 of determining whether the covered cameras 14d and 14g are positioned at a horizontal or vertical side of the central screen 13, camera driving operations S123 to S128 of driving the covered cameras 14d and 14g and identifying the driver’s eyes, and an information storing operation S129 of storing, by the control unit, pieces of distance information between each of the cameras 14a to 14h and the driver’s eyes in the control unit.

The first position determining operation S121 includes determining whether the covered cameras 14d and 14g, which are covered by the steering wheel 20 and cannot be identified by the driver, are positioned at the apex of the central screen 13 of the display module 10.

The second position determining operation S122 includes determining whether the covered cameras 14d and 14g are positioned at the horizontal or vertical side of the central screen 13 when the covered cameras 14d and 14g are not positioned at the apex of the central screen 13 in the first position determining operation S121.

Through the first position determining operation S121 and the second position determining operation S122, the blind spot of the central screen 13 is determined by driving the covered cameras 14d and 14g until the driver’s eyes are identified according to the positions of the covered cameras 14d and 14g.

In the first position determining operation S121, when the covered cameras 14d and 14g are positioned at the apex of the central screen 13, the control unit vertically moves or tilts the covered cameras 14d and 14g so that the covered cameras 14d and 14g identify the driver’s eyes and collect distance information (S123), and the control unit moves or tilts the covered cameras 14d and 14g in a left-right direction so that the covered cameras 14d and 14g identify the driver’s eyes and collect distance information (S124). The pieces of information collected through the first camera driving operation S123 and the second camera driving operation S124 are stored in the control unit.

In addition, in the second position determining operation S122, when the covered cameras 14d and 14g are positioned at the vertical side of the central screen 13, the control unit moves the covered cameras 14d and 14g upward or tilts the covered cameras 14d and 14g upward so that the covered cameras 14d and 14g identify the driver’s eyes and collect distance information (S125), and the control unit moves or tilts the covered cameras 14d and 14g downward so that the covered cameras 14d and 14g identify the driver’s eyes and collect distance information S126). The pieces of information collected through the third camera driving operation S125 and the fourth camera driving operation S126 are stored in the control unit.

In addition, in the second position determining operation S122, when the covered cameras 14d and 14g are positioned at the horizontal side of the central screen 13, the control unit moves or tilts the covered cameras 14d and 14g to the left so that the covered cameras 14d and 14g identify the driver’s eyes and collect distance information (S127), and the control unit moves or tilts the covered cameras 14d and 14g to the right so that the covered cameras 14d and 14g identify the driver’s eyes and collect distance information (S128). The pieces of information collected through the fifth camera driving operation S127 and the sixth camera driving operation S128 are stored in the control unit.

In FIG. 3, since the camera 14d positioned at a middle left and the camera 14g positioned at a lower middle are covered by the steering wheel 20, the covered cameras 14d and 14g are moved or tilted to be positioned outside the blind spot to determine the blind spot.

The pieces of information collected through the first camera driving operation S123 to the sixth camera driving operation S128 are stored in the control unit.

The blind spot calculating operation S130 includes reflecting the shape of the steering wheel 20, which is pre-stored in the control unit, in the display module 10 and calculating, by the control unit, an area of the display module 10, which is covered by the steering wheel 20 and cannot be identified by the driver.

Since the steering wheel 20 is provided in various forms, even if the covered cameras 14g and 14h are the same, an actual blind spot of the central screen 13 varies depending on the shape of the steering wheel 20.

Accordingly, the blind spot calculating operation S130 includes matching the shape of the steering wheel 20, which is pre-stored in the control unit, with the information of the covered cameras 14d and 14g and determining the blind spot in the central screen 13. In FIG. 3, since the covered cameras 14d and 14g move a predetermined distance along the horizontal and vertical sides to identify the driver’s eyes, and when the pre-stored shape of the steering wheel 20 is matched with the horizontal and vertical sides, the blind spot in the central screen 13 may be determined.

Thereafter, by determining whether the mode in which the blind spot is determined is ended (S140), the blind spot caused by the steering wheel 20 may be confirmed.

Hereinafter, a method of providing a virtual effect of a vehicle according to the present disclosure will be described.

The method of providing a virtual effect of a vehicle according to the present disclosure includes a terrain mode entering operation S201 of inputting the fact that a vehicle has entered a terrain mode to the control unit, a screen activation determining operation S206 of determining, by the control unit, whether a content is being displayed through the central screen 13 of the display module 10, an effective area identifying operation S207 of identifying an effective area of the central screen 13, which may be identified by the driver, and an effect exhibiting operation S211 of exhibiting an effect according to the terrain mode of the vehicle in the effective area according to a manipulation direction of the steering wheel 20.

The method of providing a virtual effect of a vehicle according to the present disclosure causes an effect corresponding to the terrain mode of the vehicle to be displayed on the display module 10. At this time, the effect is displayed in an area excluding the blind spot set by the above method of determining a blind spot of a display module caused by the steering wheel.

In addition, the method of providing a virtual effect of a vehicle according to the present disclosure is also performed by a control unit (not illustrated) which stores the method as logic. The control unit receives information such as a set value of the terrain mode of the vehicle, a steering angle of the steering wheel, a vehicle speed, and the like and receives information displayed through the display module. The control unit applies the logic to be described below to the received information so that an effect suitable for the terrain mode of the vehicle is displayed on the display module.

In the terrain mode entering operation S201, the driver selects the terrain mode so that the vehicle enters the terrain mode. For example, when the driver manipulates a knob, a button, or the like inside the vehicle, an output value thereof is input to the control unit so that the control unit recognizes that the vehicle has entered the terrain mode.

In a specific mode selecting operation S202, the driver selects one of specific modes of the terrain mode. Typically, since the terrain mode includes a sand mode, a mud mode, a snow mode, and an automatic mode as specific modes, the driver selects one of the specific modes, and the specific mode selected by the driver is input to the control unit.

An automatic mode determining operation S203 includes determining whether the driver has selected the automatic mode among the specific modes of the terrain mode. That is, the control unit determines whether the specific mode of the terrain mode selected by the driver is the automatic mode or is one of the sand mode, the mud mode, and the snow mode.

A mode identifying operation S204 is executed when the driver selects the automatic mode in the automatic mode determining operation S203. When the automatic mode of the terrain mode is selected as the specific mode, a mechanism which determines whether the vehicle performs the terrain mode in one of the sand mode, the mud mode, and the snow mode by identifying a road surface on which the vehicle travels using slip states or the like of the wheels of the vehicle and the road surface is initiated, and based on its result, it is determined that the specific mode of the terrain mode is one of the sand mode, the mud mode, and the snow mode. Accordingly, the control unit determines whether to perform the terrain mode as one of the sand mode, the mud mode, and the snow mode.

A specific mode storing operation S205 includes storing one of the sand mode, the mud mode, and the snow mode as the specific mode of the terrain mode in the control unit. That is, a specific mode directly selected by the driver or a specific mode determined by the vehicle is stored. This is intended to be used in the effect exhibiting operation S211 to be described below.

The screen activation determining operation S206 includes determining, by the control unit, whether the content is displayed through the central screen 13 of the display module 10. In the display module 10, the cluster 11 and the AVNT 12 display essential information for traveling, and the central screen 13 positioned between the cluster 11 and the AVNT 12 displays additional information. In the present disclosure, since the central screen is used to exhibit an effect, it is determined whether the content is already displayed on the central screen 13.

For example, when the central screen 13 displays an analog clock or a digital clock, displays a photo set by the driver, or is set to a panel for an air conditioning operation, these need to be displayed first. Accordingly, the control unit confirms that the central screen 13 is not actually being used through the screen activation determining operation S206.

In a state in which the content is not displayed on the central screen 13 through the screen activation determining operation S206, an effect corresponding to the terrain mode is displayed on the central screen 13 through the effect exhibiting operation S211 to be described below.

The effective area identifying operation S207 includes determining the effective area of the central screen 13 in which the effect may be exhibited. As described above, through the method of determining a blind spot of a display module caused by a steering wheel, it is determined that the blind spot which cannot be identified by the driver due to the steering wheel 20 is present on the central screen 13, and using this, the effective area of the central screen 13, which may be identified by the driver, is identified. That is, in the effective area identifying operation S207, the control unit may set an area excluding the blind spot as the effective area which may be identified by the driver.

However, the entire effective area is not used to exhibit the effect suitable for the terrain mode of the vehicle, and a part of the effective area may be used to exhibit the effect.

An effect area setting operation S208 includes determining an area of the effective area, which is used for exhibiting the effect. The control unit determines that the part of the effective area is the area to be used for exhibiting the effect.

Only when the effect is linked to the operation of the steering wheel 20, the driver may feel the fun of driving, and thus it is determined that an area adjacent to the steering wheel 20 is the area to be used for exhibiting the effect.

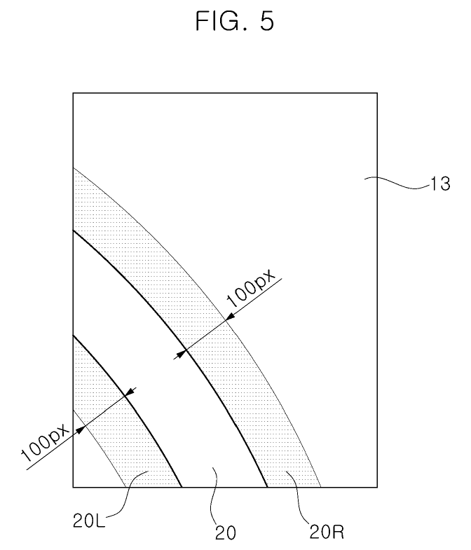

Specifically, in the case of determining the blind spot of the central screen 13 in the method of determining a blind spot of a display module caused by a steering wheel, effect areas 20L and 20R having a predetermined width are set at left and right sides of the blind spot. Since the central screen 13 is a display in which a plurality of pixels are arranged, the pixels set outside the blind spot are set to the effect areas 20L and 20R. FIG. 5 illustrates an example in which 100 pixels are set to the effect areas 20L and 20R at both sides of the blind spot covered by the steering wheel 20.

An effect intensity calculating operation S209 includes calculating the intensity of the effect exhibited through the effect areas 20L and 20R.

When an effect according to the specific mode of the same terrain mode is exhibited through the effect areas 20L and 20R, the fun is decreased, and the intensity is given to the effect, thereby increasing the fun amount.

Specifically, the intensity of the effect may be set to increase as the speed of the vehicle increases. In addition, the intensity of the effect increases as the steering angle of the vehicle increases.

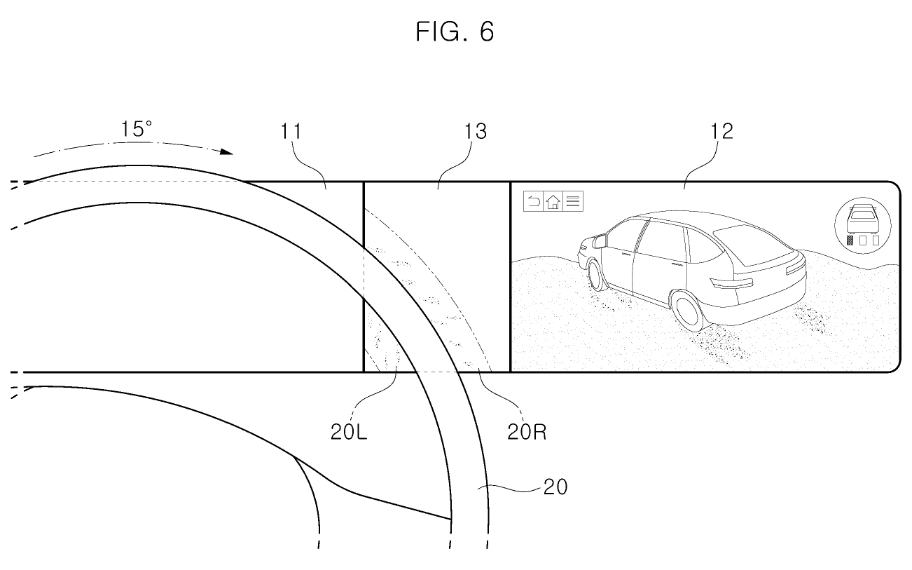

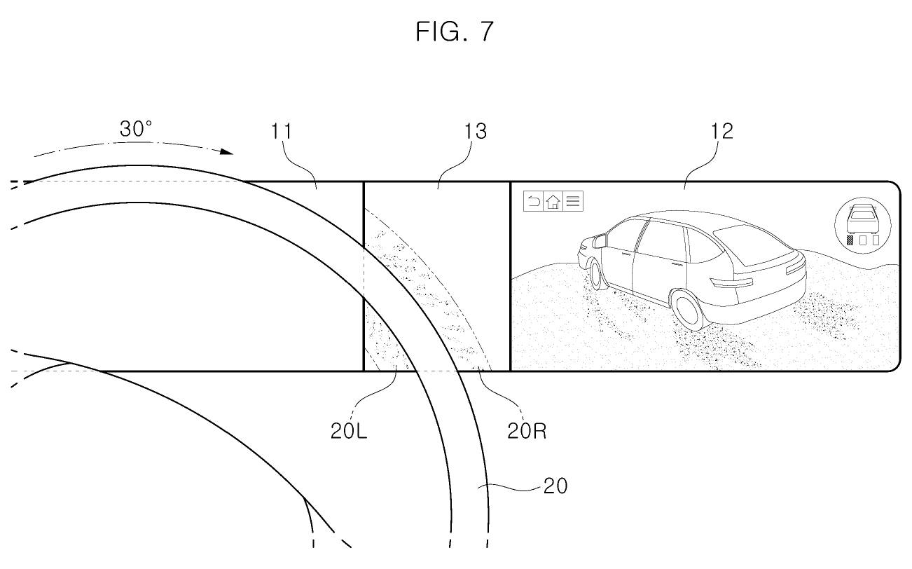

For example, when the specific mode of the terrain mode is set to sand mode, the effect of more sand being sprinkled is exhibited as the steering angle increases. Since the steering angle is larger in FIG. 7 (the steering angle of 30 degrees) than in FIG. 6 (the steering angle of 15 degrees), an effect such as more sand being sprinkled on the effect areas 20L and 20R is exhibited.

In addition, the intensity of the effect may be set considering both the speed of the vehicle and the steering angle.

However, since no process of detecting the manipulation of the steering wheel 20 is present from the terrain mode entering operation S201 to the effect intensity calculating operation S209, it is preferable to calculate the intensity in advance for each steering angle of the steering wheel 20. It is applied to the vehicle speed in the same manner, and the intensity may be calculated in advance for each vehicle speed.

In a steering direction determining operation S210, the control unit determines a manipulation direction of the steering wheel 20. When the steering wheel 20 is not manipulated, less sand, mud or snow is blown from the wheels of the vehicle, but when the steering wheel 20 is manipulated, the amount of blown sand, mud or snow increases, and thus the manipulation direction of the steering wheel 20 is determined.

An effect exhibiting operation S211 includes exhibiting an effect according to the terrain mode of the vehicle in the effective area according to the manipulation direction of the steering wheel 20. The effect according to the terrain mode is exhibited in the effective area of the central screen 13, particularly, in the effect areas 20L and 20R.

In this case, the effect display start area is determined in the effect exhibiting operation S211 according to the manipulation direction of the steering wheel 20. That is, when the steering wheel 20 is manipulated to turn left, the effect exhibiting operation S211 includes exhibiting the effect from the effect area 20R at the right of the blind spot, and when the steering wheel 20 is manipulated to turn right, the effect exhibiting operation S211 includes exhibiting the effect from the effect area 20L at the left of the blind spot. Referring to FIGS. 6 and 7, the steering wheel 20 is manipulated to turn right, but at this time, the effect starts to be exhibited from the effect area 20L at the left so that the effect is also exhibited in the effect area 20R at the right.

In addition, first, the effect is shown more significantly in the effect areas 20L and 20R in which the effect is exhibited. That is, since FIGS. 6 and 7 illustrate a case in which when the steering wheel 20 turns right, a greater effect is exhibited on the effect area 20L at the left.

Meanwhile, a virtual screen to which the effect is applied to the outside of the vehicle is provided not only on the central screen but also on the AVNT 12.

Thereafter, when the steering wheel 20 is continuously manipulated, the process returns to the terrain mode entering operation S201 and the logic is repeatedly performed, and when the manipulation of the steering wheel 20 is stopped, the effect does not need to be exhibited any more, and thus the logic may be ended.

1. A method of determining a blind spot of a display module caused by a steering wheel, the method comprising:
allowing, by a control unit, a synchronization operation of one or more cameras installed on a display module to identify a driver’s eyes;
a blind spot determining operation of driving, by the control unit, a camera among the one or more cameras, of which a view is blocked by a steering wheel and which is unable to identify the driver’s eyes, and identifying the driver’s eyes; and
a blind spot calculating operation of reflecting, by the control unit, a shape of the steering wheel, which is pre-stored in the control unit, in the display module and calculating an area of the display module, which is covered by the steering wheel and is unable to be identified by the driver.

2. The method of claim 1, wherein the synchronization operation includes:
a synchronization start operation in which the one or more cameras each start to identify the driver’s eyes; and
a covered camera determining operation of determining whether a covered camera among the one or more cameras, which is covered by the steering wheel and is unable to identify the driver’s eyes, is present.

3. The method of claim 2, further comprising a synchronization completion determining operation of determining whether the one or more cameras have started to identify the driver’s eyes between the synchronization start operation and the covered camera determining operation.

4. The method of claim 1, wherein the blind spot determining operation includes:
a first position determining operation of determining whether a covered camera which is covered by the steering wheel and is unable to be identified by the driver is positioned at an apex of a central screen of the display module;
a second position determining operation of determining whether the covered camera is positioned at a horizontal or vertical side of the central screen;
a camera driving operation of driving the covered camera and identifying the driver’s eyes; and
an information storing operation of storing, by the control unit, distance information between each camera and the driver’s eyes.

5. The method of claim 4, wherein, in the first position determining operation,
when the covered camera is positioned at the apex of the central screen,
the control unit vertically moves or vertically tilts the covered camera so that the covered camera identifies the driver’s eyes and collects the distance information, and
the control unit moves or tilts the covered camera in a left-right direction so that the covered camera identifies the driver’s eyes and collects the distance information.

6. The method of claim 4, wherein, in the second position determining operation,
when the covered camera is positioned at a vertical side of the central screen,
the control unit moves or tilts the covered camera upward so that the covered camera identifies the driver’s eyes and collects the distance information, and
the control unit moves or tilts the covered camera downward so that the covered camera identifies the driver’s eyes and collects the distance information.

7. The method of claim 4, wherein, in the second position determining operation,
when the covered camera is positioned at a horizontal side of the central screen,
the control unit moves or tilts the covered camera to a left so that the covered camera identifies the driver’s eyes and collects the distance information, and
the control unit moves or tilts the covered camera to a right so that the covered camera identifies the driver’s eyes and collects the distance information.

8. The method of claim 1, wherein the camera is a depth camera configured to recognize an object in a three-dimensional space.

9. A method of providing a virtual effect of a vehicle, comprising:
a terrain mode entering operation of inputting the fact that the vehicle has entered a terrain mode to a control unit;
a screen activation determining operation of determining, by the control unit, whether a content is displayed through a central screen of a display module;
an effective area determining operation of determining an effective area of the central screen, which is able to be identified by a driver; and
an effect exhibiting operation of exhibiting an effect according to the terrain mode of the vehicle in the effective area according to a manipulation direction of a steering wheel.

10. The method of claim 9, further comprising, between the effective area determining operation and the effect exhibiting operation,
an effect area setting operation of setting an effect exhibiting area in which the effect is exhibited to a predetermined width from a blind spot of the central screen, which is covered by the steering wheel; and
a steering direction determining operation of determining the manipulation direction of the steering wheel,
wherein an effect exhibiting start area is determined in the effect exhibiting operation according to the manipulation direction of the steering wheel.

11. The method of claim 10, wherein, when the steering wheel is manipulated to turn left, the effect exhibiting operation includes exhibiting the effect from an effect area at a right of the blind spot, and
when the steering wheel is manipulated to turn right, the effect exhibiting operation includes exhibiting the effect from an effect area at a left of the blind spot.

12. The method of claim 11, further comprising an effect intensity calculating operation of calculating an intensity of the effect between the effective area setting operation and the steering direction determining operation.

13. The method of claim 12, wherein, in the effect intensity calculating operation, the control unit calculates the intensity of the effect in proportion to at least one of a speed of the vehicle and a steering angle of the steering wheel.

14. The method of claim 9, further comprising, between the terrain mode entering operation and the screen activation determining operation,
a specific mode determining operation of causing the driver to select a specific mode of the terrain mode;
an automatic mode determining operation of determining whether an automatic mode among the specific modes of the terrain mode has been selected; and
a specific mode storing operation of storing the specific mode as one of a sand mode, a mud mode, and a snow mode in the control unit.

15. The method of claim 14, wherein, in the automatic mode determining mode,
when it is determined that the driver selects the automatic mode among the specific modes of the terrain mode,
a mode identifying operation of identifying, by the control unit, whether to perform the terrain mode using one of the sand mode, the mud mode, and the snow mode is performed.
